(19) United States
(12) Patent Application Publication
(10) Pub. No.: US 2002/0009151 A1
(43) Pub. Date: Jan. 24, 2002

(54) MPEG-4 encoder and output coded signal of such an encoder

(76) Inventor: Philippe Gentric, Issy les Moulineaux (FR)

Correspondence Address: Philips Electronics North America Corporation, 580 White Plains Road, Tarrytown, NY, 10591, US

(21) Appl. No.: 09/905,130

(22) Filed: Jul. 13, 2001

(30) Foreign Application Priority Data
Jul. 13, 2000 (EP) 00402027.7

(51) Int. Cl. H04N 7/12

(52) U.S. Cl. 375/240.26

(57) ABSTRACT

The invention relates to an MPEG-4 encoder in which the encoded content is stored in the .mp4 file format together with specific additional hint tracks. These tracks include a pre-segmentation information indicating how to fragment the encoded data, organized in Access Units, in order to match the size of the packets used for a packetized transmission (ATM, MPEG-2 TS, IP, . . . ). According to the invention, the fragmentation information, structuring the coded bitstream into independent entities, is stored during encoding in a fragment structure independent from the .mp4 file. The invention also relates to a coded signal available at the output of such an encoder, and to a terminal receiving said coded signal and reading it according to a file structure having the appropriate syntax.

The present invention relates to an MPEG-4 encoder in which the bitstream corresponding to the output encoded content to be sent by means of a transmission network is stored in the so-called .mp4 file format as media tracks and the transport mechanism is stored by adding specific hint tracks, one per media track, said hint tracks being used to include, for the adaptation of said encoded content to the size of the transmission packets corresponding to a given type of network, a pre-segmentation information indicating how to fragment the MPEG-4 data entities (or Access Units) stored in the media tracks in order to match the size of said packets. This invention finds an application in the context of video on demand according to the MPEG-4 standard, using therefore the MPEG-4 file format (file extension .mp4).

In order to handle transport via a network, or streaming, the standards MPEG-1 and MPEG-2 defined a bit stream structure that could be written in a file and, separately, the transport mechanisms (for example, MPEG-2 TS). However a given content type can be transported in a large variety of transport (or network) systems, ATM or IP for example, each of which has specific properties. A specific transport set of mechanism has then to be defined, for optimality reasons, which leads to the following problem: if a content maker has defined how to store an encoded content in a given “transport” format, said format will probably not be reusable optimally on a different network.

The specifications of MPEG-4 Systems define a file format, .mp4, which has a specific way to handle streaming: the encoded content is stored in the .mp4 file format as media tracks (for example, audio is a media track, video is another media track, etc). Additionally, the transport mechanism can be stored in the file by adding specific hint tracks, one per media track: with such a mechanism, a single file can be used as a single container for the media data themselves, in the media tracks, and for transport specific data, in the hint tracks. And, if this file is authored for transport on two different networks, there will be two hint tracks per media track, and so on.

It must be noted that these hint tracks are optional: they are not needed for instance for local playback (from a disk). Moreover, these hint tracks have a non-negligible size. Actually, optimal hinting, from a server performance point of view, requires files with more than two times the size of the original file, by storing directly the network packets in the hint tracks. Hint tracks are therefore not wanted in the file if one is not sure to need them.

The MPEG-4 file format is defined normatively: the data entities stored in the media tracks are MPEG-4 Access Units, which are generally larger than a network packet. The role of the hint track will then be to store the information about how the network packets are made, how they can be filled: the hint track indeed contains pre-segmentation information so that a server knows how to fragment each Access Unit into network packets. Therefore one can first generate media tracks and store them in a .mp4 file, and then use a separate hinter program in order to parse this file, analyze the Access Unit structure, and generate suitable additional hint tracks.

However, there are two main ways to generate the packets: either a blind segmentation, constructing packets that correspond to the maximum network packet size, or a smart segmentation, relying on error resilience strategies defined for the concerned media. If losses occur, it may be difficult for a decoder (at the client side) to correctly decode a bit stream after a gap. As bitstreams are generally designed for minimal bandwidth usage (which means that redundancy is removed as much as possible), recognizing an item requires some context which can be lost when a fragment of the bit stream is itself lost.

In order to solve this issue, the bitstreams are structured in independent entities (or fragments), so that each fragment can be transported in one network packet. If a packet is lost, the next one, which is an independent entity, enables the decoder to recover some context in spite of the loss. The fragmentation information, which is media specific (it is different for each media type: audio, video, . . . , and even for distinct encoding options), is located in the hint tracks of the .mp4 file format and available at the output of the encoder. In case of packet loss, if the media is stored in a .mp4 file during encoding without hint tracks, the smart fragmentation information is lost, and the hinter program can only do a blind segmentation, which results in decoding problems (large presentation quality degradation).

It is therefore an object of the invention to propose an MPEG-4 encoder implementing another solution for the transport of the data entities.

To this end, the invention relates to an MPEG-4 encoder as defined in the introductory part of the description and which is moreover such that the fragmentation information, structuring the coded bitstream in entities that are now independent in order to recover some context even if a packet is lost, is stored during encoding in a fragment structure file which is independent of said .mp4 file.

For a content producer, a solution would consist in generating always two .mp4 files, one with the hint tracks and another one without them. However, since hinted files are more than twice as large as the original file, the storage required in the case of this conventional solution is more than three times the original media size. The proposed solution is much more efficient because the fragmentation information file is very small compared to the media size.

Another solution would be to always generate a hinted file and use a specific tool to edit this file, remove the hinted track and produce a .mp4 file with only the media data. However this solution involves a separate edition step. Furthermore the hint tracks are network specific (a different hint track is required for ATM, MPEG-2 TS, or IP) and this solution does not allow to go easily from, say, ATM transport to IP transport. On the contrary, with the solution according to the invention, the fragmentation information file containing all the required information is not network specific and can therefore be used for the generation of any network specific hinted file.

The invention also relates to a coded signal available at the output of such an encoder in the form of a bitstream to be sent by means of a transmission network and including on one side media data, stored in the so-called .mp4 file format, and on the other side a pre-segmentation information indicating how to fragment the MPEG-4 data entities (or Access Units) corresponding to said media data in order to match the size of the packets of said transmission network.

Moreover, the invention relates to an MPEG-4 terminal receiving such a coded signal and which is read according to a file structure having the following syntax:

Loop on MPEG-4 Access Units until end-of-file, and, for each Access Unit:

Read the number of fragments N

Loop on fragments until N, and, for each fragment:

Read the fragment size (in bits)

End-of-loop on fragments

End-of-loop on Access Units.

The principle of the invention is to store separately during encoding the fragmentation information. In that case, the encoding process, instead of generating only one file (the .mp4 file), will produce two files simultaneously: the .mp4 file with the media, and the fragment structure file. If after encoding of the content, a producer decides to use the content in a streaming application, hinting is required. Normally, only blind segmentation can be done. However, if the separate file containing optimal (media specific) fragmentation has been archived, it can be used by a hinter program—in conjunction with the .mp4 file—to generate a new .mp4 file containing optimal hint tracks. This hinted file can then be used by a video-on-demand server, for multiple playback.

Alternatively, a broadcasting application could use the hinted file for “live” broadcast of the content, or also the original (i.e. non-hinted) .mp4 file and the fragment structure file for said “live” broadcast of the content.

The proposed file structure has a syntax as now indicated:

Loop on MPEG-4 Access Units until end-of-file, and, for each Access Unit:

Read the number of fragments N

Loop on fragments until N, and, for each fragment:

Read the fragment size (in bits)

End-of-loop on fragments

End-of-loop on Access Units.

The reason the fragment size should be in bits is that some media have optimal fragments the size of which is not a multiple of 8 bits (i.e. not an integer number of bytes). An example of such a situation is given by the MPEG-4 video “Data Partitions” Access Unit fragments. If the file is a binary file, since the number of fragments cannot be very large, 16 bits should be enough for N. Similarly, 16 bits should be enough for the fragment size (maximum fragment size would be more than 8000 bytes).

An alternative is to use an ASCII (plain text) representation of numbers with separator character, typically a space and/or end of line character, since standard C functions such as f s c a n f (“%d”) can then be used.

1. An MPEG-4 encoder in which the bitstream corresponding to the output encoded content to be sent by means of a transmission network is stored in the so-called .mp4 file format as media tracks and the transport mechanism is stored in said file by adding specific hint tracks, one per media track, said hint tracks being used to include, for the adaptation of said encoded content to the size of the transmission packets corresponding to a given type of network, a pre-segmentation information indicating how to fragment the MPEG-4 data entities (or Access Units) stored in the media tracks in order to match the size of said packets, said encoder being such that the fragmentation information, structuring the coded bitstream in entities that are now independent in order to recover some context even if a packet is lost, is stored during encoding in a fragment structure file which is independent of said .mp4 file.

2. A coded signal available at the output of an MPEG-4 encoder in the form of a bitstream to be sent by means of a transmission network and including on one side media data, stored in the so-called .mp4 file format, and on the other side a pre-segmentation information indicating how to fragment the MPEG-4 data entities (or Access Units) corresponding to said media data in order to match the size of the packets of said transmission network.

3. An MPEG-4 terminal, receiving a coded signal according to claim 2 and which is read according to a file structure having the following syntax:
Loop on MPEG-4 Access Units until end-of-file, and, for each Access Unit:
Read the number of fragments N
Loop on fragments until N, and, for each fragment:
Read the fragment size (in bits)
End-of-loop on fragments
End-of-loop on Access Units.

4. An MPEG-4 terminal according to claim 3, in which a hinter program is provided for generating with the .mp4 file a new file .mp4 containing optimal hint tracks, said hinted file being then used by the terminal according to the concerned application.
